(19) United States
(12) Patent Application Publication
(10) Pub. No.: US 2016/0274259 A1
(43) Pub. Date: Sep. 22, 2016

(54) BURIAL DEPTH DETECTION APPARATUS AND METHOD FOR MARINE SEISMIC SURVEYS

(71) Applicant: CGG SERVICES SA, Massy Cedex (FR)

(72) Inventor: Pierrick DANIEL, Longjumeau (FR)

(21) Appl. No.: 15/070,322

(22) Filed: Mar. 15, 2016

Related U.S. Application Data
(60) Provisional application No. 62/133,486, filed on Mar. 16, 2015.

(51) Int. Cl. G01V 1/38; B63C 11/48; B63G 8/00

(52) U.S. Cl. CPC G01V 1/3808; G01V 1/3852; B63G 8/001; B63C 11/48; B63G 2008/002; B63B 2211/02

(57) ABSTRACT

An autonomous underwater vehicle (AUV) for recording seismic signals during a marine seismic survey. The AUV includes a body having a base face and first and second sides, a burying mechanism attached to the body and configured to bury the base face into the sea floor, a depth burying detection apparatus attached to the body and configured to detect a presence of an ambient solid material on the first or second side of the body, and a seismic sensor configured to record seismic signals.

### CROSS REFERENCE TO RELATED APPLICATIONS

The present application claims the benefit of priority under 35 U.S.C. §119(e) to U.S. Provisional Application No. 62/133,486 filed on Mar. 16, 2015, the entire content of which is hereby incorporated by reference into the present application.

### BACKGROUND

1. Technical Field

Embodiments of the subject matter disclosed herein generally relate to methods and systems and, more particularly, to mechanisms and techniques for determining the status of a coupling between the ocean bottom and an autonomous underwater vehicle (AUV), which carries seismic sensors for a marine seismic survey.

2. Discussion of the Background

Marine seismic data acquisition and processing generate a profile (image) of a geophysical structure under the seafloor. While this profile does not provide an accurate location of oil and gas reservoirs, it suggests, to those trained in the field, the presence or absence of these reservoirs. Thus, providing a high-resolution image of geophysical structures under the seafloor is an ongoing process.

Reflection seismology is a method of geophysical exploration to determine the properties of earth's subsurface, which is especially helpful in determining the above-noted reservoirs. Marine reflection seismology is based on using a controlled source of energy that sends the energy into the earth. By measuring the time it takes for the reflections and/or refractions to come back to plural receivers, it is possible to evaluate the depth of features causing such reflections. These features may be associated with subterranean hydrocarbon deposits.

A traditional system for generating the seismic waves and recording their reflections off the geological structures present in the subsurface includes a vessel that tows an array of seismic receivers provided on streamers. The streamers may be disposed horizontally, i.e., lying at a constant depth relative to the ocean surface. The streamers may be disposed to have other than horizontal spatial arrangements. The vessel also tows a seismic source array configured to generate a seismic wave. The seismic wave propagates downward and penetrates the seafloor until eventually a reflecting structure (reflector) reflects the seismic wave. The reflected seismic wave propagates upward until detected by the receiver(s) on the streamer(s). Based on the data collected by the receiver(s), an image of the subsurface is generated.

However, this traditional configuration is expensive because the cost of the streamers is high. New technologies deploy plural seismic sensors on the bottom of the ocean (ocean bottom stations) to improve the coupling. Even so, positioning the seismic sensors remains a challenge.

An improved approach to these problems is the use of plural AUVs for carrying the seismic sensors and collecting the seismic data. These AUVs have also the capability to bury themselves into the ocean bottom, as noted in U.S. Patent Application Publication Nos. 2014/0140170, 2014/0290554 and 2015/0003194 and also International Patent Application Publication WO 2014/090811, the entire contents of which are incorporated herein by reference. The AUVs may be launched from a deployment vessel, guided to a final destination on the ocean bottom, instructed to bury into the ocean floor and record the seismic data, and then instructed to surface for collecting the seismic data. However, some challenges still remain with such method as currently it is difficult to estimate the burial depth of each AUV.

Accordingly, it would be desirable to provide systems and methods that provide an inexpensive and simple way to achieve good coupling between the AUV's seismic sensors and the ocean bottom and also to quantify (measure or estimate) such coupling.

### SUMMARY

According to one exemplary embodiment, there is an autonomous underwater vehicle (AUV) for recording seismic signals during a marine seismic survey. The AUV includes a body having a base face and first and second sides; a burying mechanism attached to the body and configured to bury the base face into the sea floor; a depth burying detection apparatus attached to the body and configured to detect a presence of an ambient solid material on the first or second side of the body; and a seismic sensor configured to record seismic signals.

According to another embodiment, there is a depth burying detection apparatus to be attached to an autonomous underwater vehicle (AUV) for recording seismic signals during a marine seismic survey. The apparatus includes an outside burying sensor located on a first outside face of the AUV, at a given height d from a base face of the AUV; an internal reference sensor located inside the AUV and exposed only to sea water; and an electrical circuit located inside the AUV and connected to the outside burying sensor and the internal reference sensor.

According to still another embodiment, there is a method for controlling a burying process of an autonomous underwater vehicle (AUV). The method includes a step of landing the AUV on the ocean bottom; a step of activating a burying mechanism, attached to the AUV, to bury a base face of the AUV into the ocean bottom; a step of measuring with an outside burying sensor, a parameter of an ambient at a location on a first lateral side of the AUV, wherein the outside burying sensor is attached to the first lateral side at the location; and a step of de-activating the burying mechanism when the parameter indicates a presence of an ambient solid material at the location.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a marine acquisition system that uses AUVs for recording seismic data;

FIG. 2 is a schematic diagram of an AUV buried a certain distance into the ocean floor;

FIG. 3 is a cross-section of the AUV of FIG. 2;

FIG. 4 is a schematic diagram of an AUV having a burying mechanism;

FIG. 5 is a schematic diagram of an AUV having a burying mechanism and a depth burying detecting apparatus;

FIG. 6 is a cross-section of the AUV of FIG. 5 when having outside burying sensors at a given depth;

FIG. 7 is a cross-section of the AUV of FIG. 5 when having outside burying sensors at two given depths;

FIG. 8 is a schematic diagram of the depth burying detection apparatus;

FIG. 9 is a schematic diagram of an electrical circuit for coordinating one outside burying sensor and an inside reference sensor;

FIG. 10 is a schematic diagram of a burying mechanism located on a base face and side faces of an AUV;

FIG. 11 is a schematic diagram of an AUV;

FIG. 12 is a schematic diagram of a marine acquisition system having AUVs with depth burying detection apparatuses;

FIG. 13 is a flowchart of a method for burying an AUV up to a desired depth; and

FIG. 14 is a flowchart of a method for controlling the burial of an AUV based on a depth burying detection apparatus.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of an AUV having a flat base that couples to the ocean bottom. However, the embodiments to be discussed next are not limited to any particular AUV or AUV shape, but they may be applied to other AUVs or other platforms (e.g., glider, buoy, node etc.) that may carry seismic sensors to the ocean bottom. Also, the following embodiments may be applied to an AUV that does not have plane faces, e.g., a tubular node.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a seismic sensing system includes plural AUVs, each having one or more seismic sensors. The seismic sensors may be one of a hydrophone, geophone, accelerometers, electromagnetic sensors, etc. If an electromagnetic sensor is used, then a source that emits electromagnetic waves may be used instead of or in addition to an acoustic source. The AUV may be a specially designed device or an off-the-shelf device so that it is inexpensive. The off-the-shelf device may be quickly retrofitted or modified to include the seismic sensors and necessary communications means to be discussed later. The AUV may include, besides or in addition to a propulsion system, a buoyancy system.

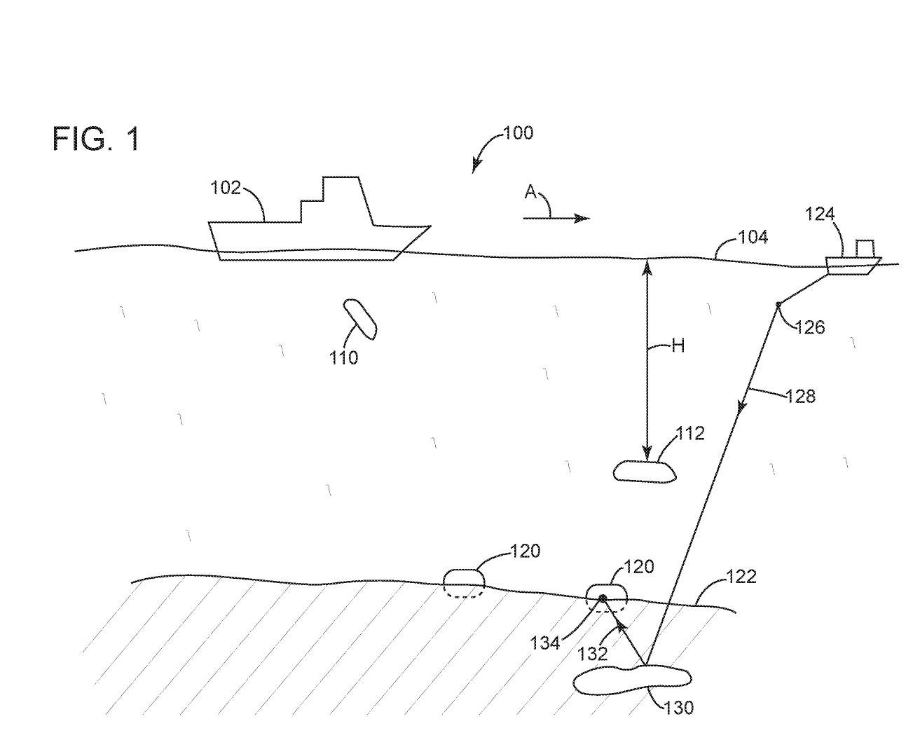

According to an embodiment illustrated in FIG. 1, a seismic acquisition system 100 includes at least one vessel 102 that travels at the water surface 104 along a travel path A. In one embodiment, vessel 102 may travel under water or be a base station deployed under water. Vessel 102 launches AUVs 110 as it travels. While some AUVs 112 are instructed to float at a certain depth H relative to the water surface 104, other AUVs 120 are instructed to bury into the ocean bottom 122. FIG. 1 shows, for simplicity, one of each of these AUVs. Note that in one embodiment, all the AUVs are floating while in another embodiment all the AUVs are buried. The same or a different vessel 124 may tow a seismic source 126, which emits seismic waves 128 toward the ocean bottom. Seismic waves 128 are reflected from a geological structure 130 underground, and the reflected wave 132 is recorded by a seismic sensor 134 carried by AUV 120.

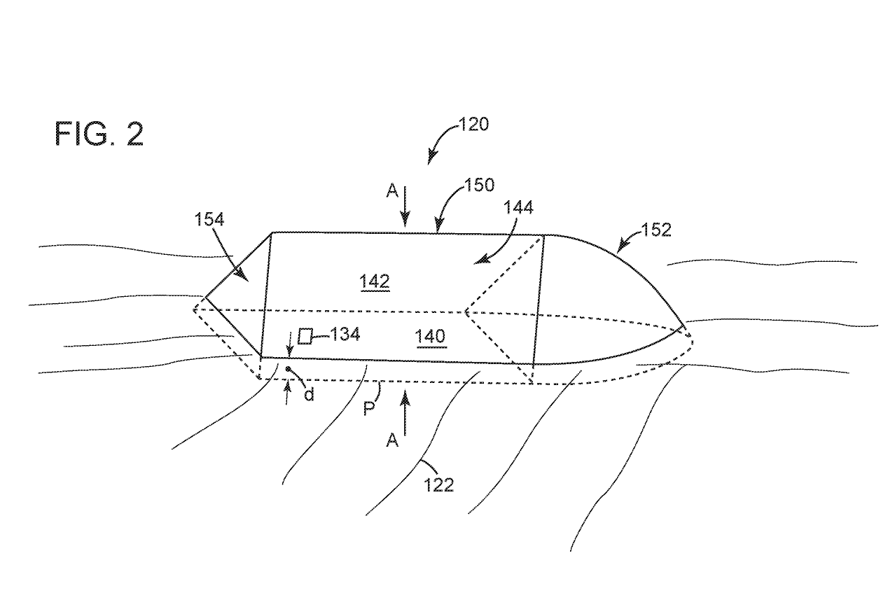

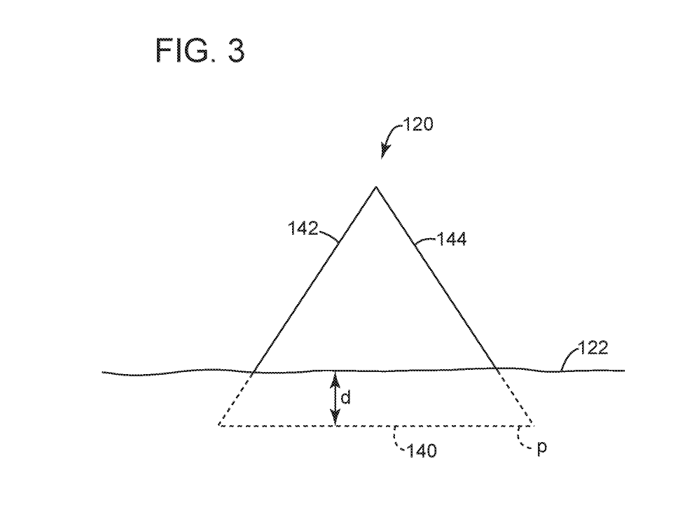

AUV 120 is shown in FIG. 2 as being partially buried in the ocean bottom 122, which may be sand. More specifically, the AUV in FIG. 2 has a base face 140 and two side faces 142 and 144 that make a triangular-like cross-section. Other cross-sections are possible. AUV 120 has a main body 150, a nose portion 152 and a tail portion 154. A perimeter P of the base face 140 is shown fully embedded into the ocean bottom. In this figure, AUV 120 is shown buried a depth (sometimes called a distance) “d” into the ocean bottom. Distance d may be measured along a line that starts at the location of the sensor and is perpendicular on the base face. FIG. 3 is a cross-section AA of AUV 120 and better illustrates the burial depth d.

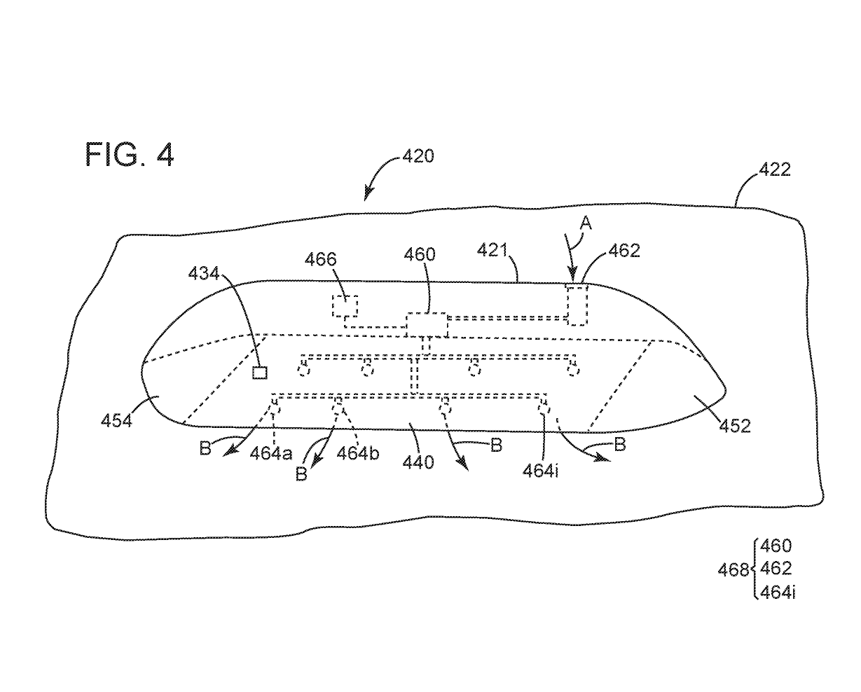

A mechanism for burying the AUV into the ocean bottom is now discussed with regard to FIGS. 4-6, which are similar to FIGS. 2-4 in U.S. Patent Application Publication 2014/0290554.

FIG. 4 illustrates an embodiment in which an AUV includes a mechanism for burying at least a portion of itself into the ocean bottom. This embodiment takes advantage of the observation that placing a shower head on top of sand (or other solid material) and sending water (at a certain speed) through the nozzles of the shower head makes the shower head to bury itself in the sand.

Thus, according to the embodiment illustrated in FIG. 4, AUV 420 has a body 421 located on top of ocean floor 422. Body 421 has a base face 440, a nose 452 and a tail 454. Base face 440 is illustrated as being flat, i.e., a plane in 2D. However, the base face may be round, semi-circular or it may have any other shape. One or more pump jets 460 (or other water pumps) are located inside body 421 and fluidly communicate with an inlet port 462 and one or more outlet ports 464i. In one embodiment, the value of “i” is between 5 and 60. Other values are possible. Note that each port may have a valve (not shown), controlled by a processor 466, and configured to be opened or closed when necessary, i.e., when needed to bury or detach the AUV from the ocean bottom. The pump jet is a marine system that creates a jet of water for propulsion. The mechanical arrangement may be, for example, a ducted propeller with nozzle, or a centrifugal pump and nozzle.

The pump jet may be electrically linked to processor 466 for coordinating its use. For example, processor 466 may decide to activate the pump jet only after determining that the AUV has landed. Further, processor 466 may be programmed to activate the pump jet for a predetermined amount of time, e.g., a few seconds or minutes prior to recording seismic data. In one embodiment to be discussed later in more detail, the processor activates the pump jet until a predetermined burial depth is achieved.

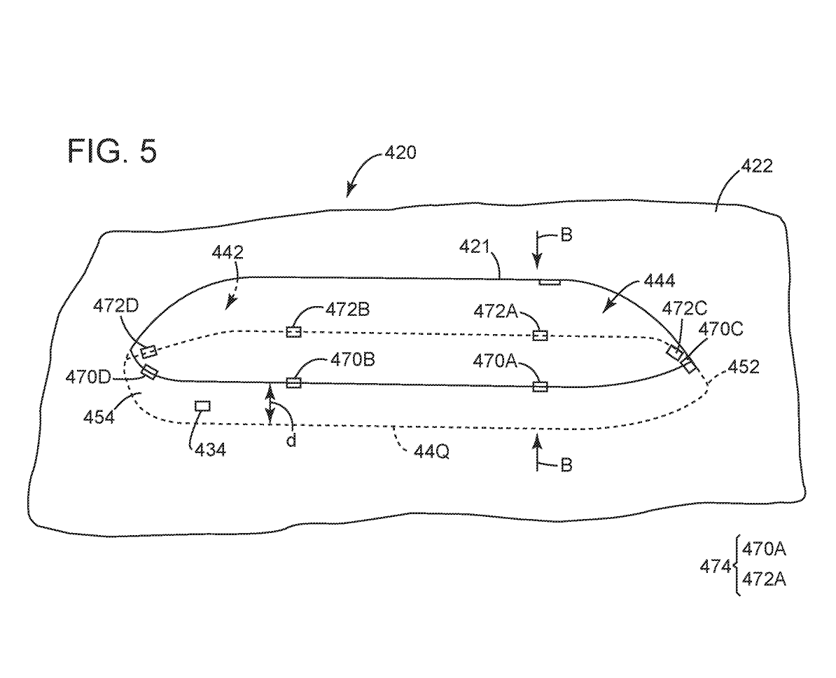

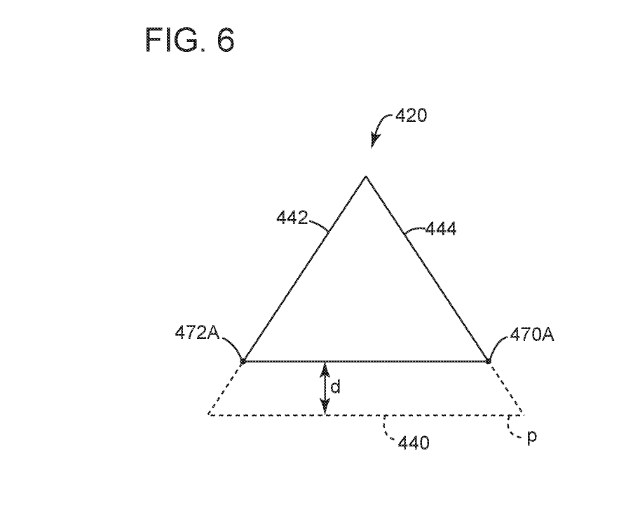

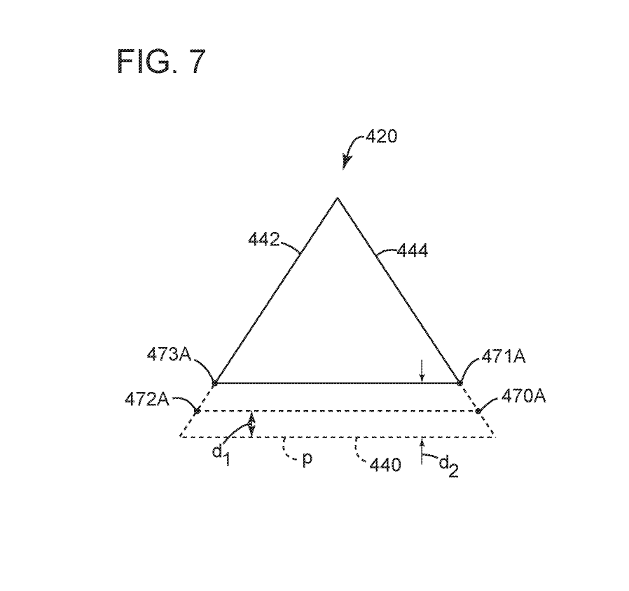

FIG. 5 shows AUV's body 421 buried a depth/distance d in the ocean floor 422 and two burying sensors 470A and 472A symmetrically located on sides 442 and 444, respectively, of the body 421. Note that AUV may have a tubular shape and thus, no sides 442 and 444. For this case, it is considered that the AUV (or node) has a base face, a top face and a side round face. Any two portions of the side face can be considered to be sides 442 and 444. FIG. 6 shows a cross-section BB of body 421, through burying sensors 470A and 472A. In one embodiment, AUV 420 has only two burying sensors 470A and 472A, one on each face. However, in another embodiment, also illustrated in FIG. 5, it is possible to have plural sensors 470A-D on one face 444 and plural sensors 472A-D on the opposite face 442. In this way, a burying accuracy may be improved. In one application, at least one sensor 470C and 472C on each face is located at the nose 452 and at least one sensor 470D and 472D on each face is located at the tail 454. In one other application, it is possible to have multiple sensors 470A and 471A located at different depths along a same side 444 of the AUV, as illustrated in FIG. 7, for allowing the AUV to bury at a desired depth d1 or d2 or to change the burying depth. Those skilled in the art can imagine that any number of burying sensors may be located on the outside skin of the body 421, at various locations along the body and at various distances relative to the base face 440. The more burying sensors, the more accurate the burying location of the AUV can be determined. A minimum configuration for determining whether the AUV is buried requires a single burying sensor.

Returning to FIG. 4, pump jet 460 together with inlet 462 and plural outlets 464i form a burying mechanism 468. Note that other burying mechanisms may be used and the one shown in FIG. 4 is just an example. Burying mechanism 468 may be used as follows: when AUV 420 reaches the ocean bottom 422, processor 466 instructs pump jet 460 to take in water from the ambient, through inlet 462, as indicated by arrow A and to expel the water through outlets 464i. Note that the AUV may have more than one inlet 462. FIG. 4 shows inlet 462 located on top of the AUV. However, other locations are possible. The water taken in by pump jet 460 is illustrated by reference A and the expelled water is illustrated by reference B. In this way, the soil (mud) on the ocean bottom 422 in the AUV's immediate vicinity is fluidized and the AUV, due to its weight and due to the potential downward action of the vertical jet pumps, starts to bury itself. This process continues until sensors 470A and 472A inform processor 466 that a desired depth d has been reached and thus, seismic sensor 434 has a good coupling with the ocean bottom.

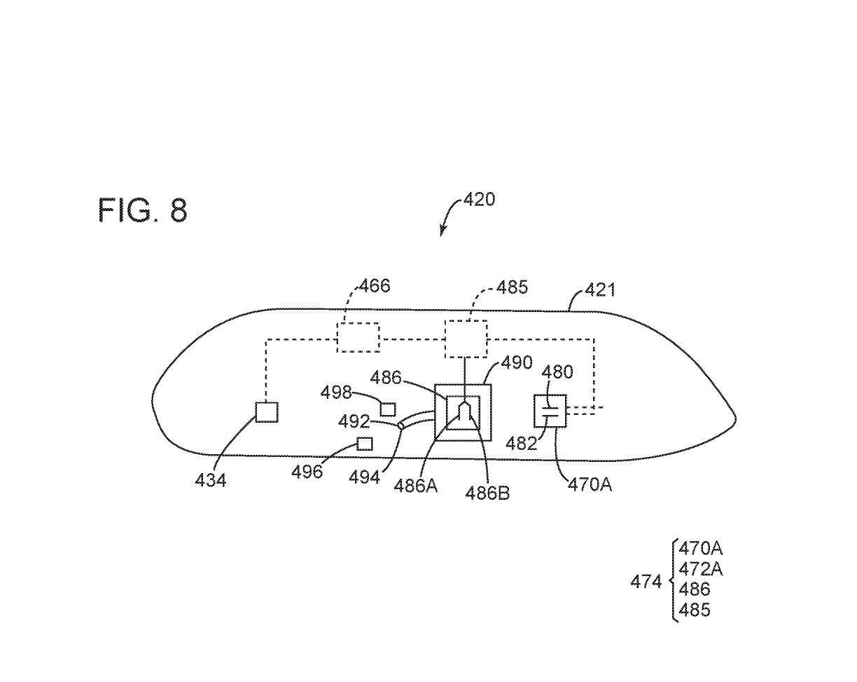

Outside burying sensors 470A and 472A are part of a depth burying detection apparatus 474 and they are located outside the body 421 for directly contacting the environment (fluids and/or solids). Outside burying sensors 470A and/or 472A may be made, in one embodiment illustrated in FIG. 8, of two electrodes (e.g., stainless steel) 480 and 482 that are connected to processor 466. The two electrodes 480 and 482 are used to measure, for example, a conductivity of the surrounding environment. This measurement can be achieved, for example, by applying a given voltage V to the two electrodes. An electronic circuit 485, which may be or not part of processor 466, applies the voltage and measures a circulating current through the circuit made with the electrodes. An inside reference sensor 486 (which also has two electrodes 486A and 486B) is located inside body 421 and shielded from interacting with the solids on the ocean bottom. Inside reference sensor 486 is located in a chamber 490, located inside body 421 and this chamber can communicate, through an intake 492, with the ambient of the AUV. However, the intake 492 is so designed to allow a fluid 496 (e.g., ambient water) to enter chamber 490, but not ambient solids 498. For example, intake 492 may be covered with a net 494 that prevents solids 498 entering chamber 490. Depth burying detection apparatus 474 includes, besides outside burying sensor 470A, inside reference sensor 486 and electrical circuit 485. Optionally, depth burying detection apparatus 474 may also include processor 466. FIG. 8 also shows seismic sensor 434, which can be located inside or outside body 421.

Electrical circuit 485 determines a same conductivity for both sensors 470A and 486 when the AUV is fully immersed in water, but different conductivities when sensor 470A is located in sand or another solid and inside reference sensor 486 communicates only with the sea water. Circuit 485 and/or processor 466 may be configured to compare the two different conductivities at given time intervals, and determine that when a difference between the two conductivities is equal to or larger than a given threshold, outside burying sensor 470A has reached the ocean bottom because it determines the presence of a solid. At this instant, the processor verifies a depth of sensor 470A relative to a desired depth, and if these two depths are within a certain range, processor 466 determines that the AUV is buried enough and instructs burying mechanism 468 to stop.

The embodiment discussed above used a single outside burying sensor 470A. However, if more outside burying sensors are distributed outside body 421, processor 466 may determine that the AUV is well buried only after determining that all burying sensors located at a same distance d relative to base face 440 are measuring a conductivity corresponding to sand or other solid material. In still another embodiment, processor 466 may relax the condition that all outside burying sensors are measuring a solid, and accept that the AUV has reached its desired burying depth if a certain percentage (e.g., 80%) of all the outside burying sensors having the same distance to the base face 440 is measuring a solid. In still another embodiment, if the seismic sensor is located at the AUV's nose, the processor may be configured to determine that the AUV has reached its desired burying depth if the outside burying sensors located on the nose part of the AUV are measuring the conductivity associated with a solid. Note that the conductivities associated with varying solids located on the ocean bottom may be experimentally determined prior to launching the AUV and stored in a memory on board the AUV. In this way, the AUV's processor simply compares the measured conductivities with those stored in the memory and decides whether a respective outside burying sensor is measuring the conductivity of a solid material or the sea water. By allowing only the sea water to enter inside chamber 490 and by measuring the conductivity of the sea water with inside reference sensor 486, a change in the salinity of the sea water with depth is automatically taken into account.

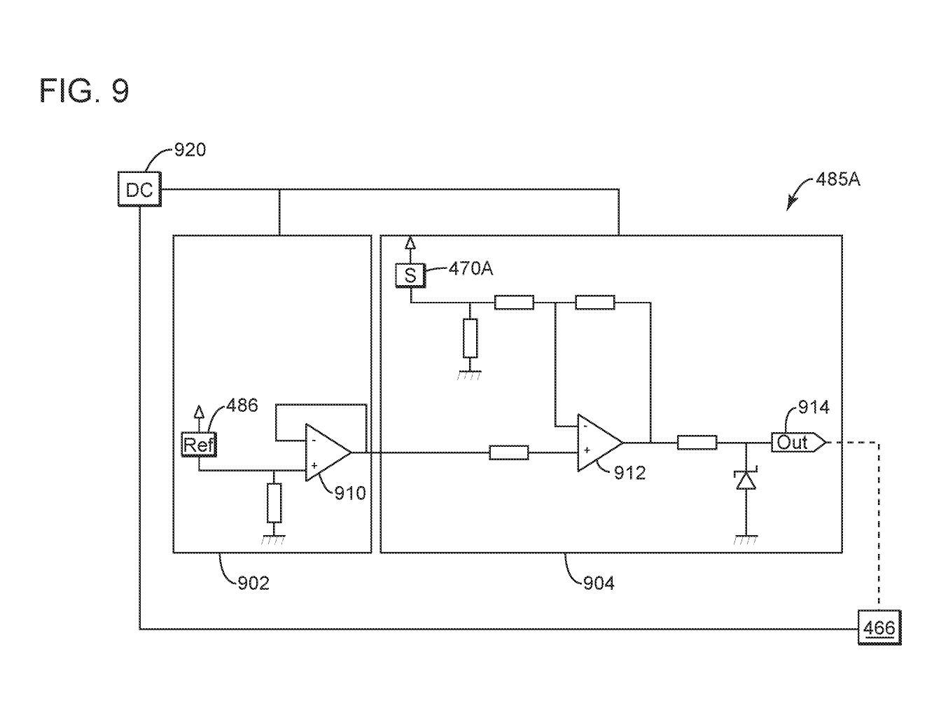

A logical scheme of electrical circuit 485 and various connections to outside and inside burying sensors is illustrated in FIG. 9. Note that only a part 485A of electrical circuit 485 is shown in FIG. 9. Part 485A illustrates how the signals from a single outside burying sensor 470A and inside reference sensor 486 are processed. Depending on how many outside burying sensors are present, the electrical circuit will include a corresponding number of parts 485A for processing the measurement for each sensor.

Part 485A may include a follower amplifier section 902 and a differential amplifier section 904. Follower amplifier section 902 may include the inside reference sensor 486 (or a port connected to such sensor) and amplifier 910. Amplifier 910 receives at one port the signal measured by the inside reference sensor and makes a copy of this signal. The resultant signal is sent to differential amplifier section 904, where a difference is made at differential amplifier 912 between the signal received from follower amplifier section and the signal measured by outside burying sensor 470A. The output from differential amplifier 912 is sent to an output port 914. When the outside burying sensor is in contact with a solid material (e.g., sand), its inner resistance increases (or its conductivity decreases), and thus a difference of potential is sensed by differential amplifier 912. Thus, the output of the differential amplifier 912 is, in this case, a voltage corresponding to logical 1, which indicates the presence of a solid material. All output ports 914 (if more than one outside burying sensor is present) are sent to processor 466 for further processing and making the decision of whether the AUV has reached its target burial depth. Processor 466 also controls a DC power source 920 for supplying power to follower amplifier and differential amplifier sections, as schematically illustrated in FIG. 9. Variations of the electrical circuit illustrated in FIG. 9 may be imagined and implemented.

Those skilled in the art would understand that outside and inside burying sensors 470A and 486 may be identical or different, and that other type of sensors may be used for measuring the conductivity of the environment. In one application, the sensors would measure another property of the environment, which gives a unique fingerprint for the ambient materials, for example, sound speed. In another application, the sensor is a light sensor (e.g., an optical fiber) that measures a light. When the sensor is not buried into the ocean bottom, the measured light is expected to be higher than when the sensor is buried into the ocean bottom.

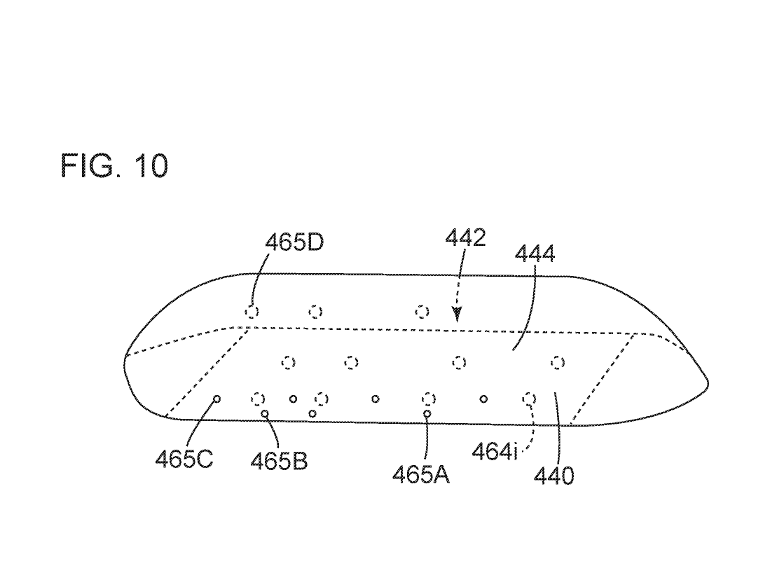

According to another embodiment, as illustrated in FIG. 10, outlets 464i may be formed not only on the base 440 face, but also on sides 444 and 442 of the AUV. FIG. 10 shows the base outlets 464i and the side outlets 465A-D.

When the acquisition of seismic data is finished, the burying mechanism 468 may also be used to detach the AUV from the ocean bottom by fluidizing the ocean bottom around the AUV similar to the sequence discussed after landing, but now the lower vertical jet pumps produce a vertical upward force. Optionally, the pump jet expels water through the base outlets 464i and/or the side outlets 465i with a higher speed than when burying. In other words, the processor 466 may be programmed to achieve a desired water speed, i.e., low speed for burying and high speed for detaching the AUV. Optionally, the burying mechanism may be used to slow down the AUV before landing on the ocean bottom.

In one embodiment, after the AUV was buried at a certain burying depth d2 as illustrated in FIG. 7, processor 466 periodically instructs the outside burying sensors to measure the conductivity of the environment, and, if the processor detects that the AUV has detached from the ocean bottom, to attempt again to bury itself. The processor and/or electrical circuit may instruct the outside burying sensors to continuously or periodically measure the conductivity of the ambient or any other property.

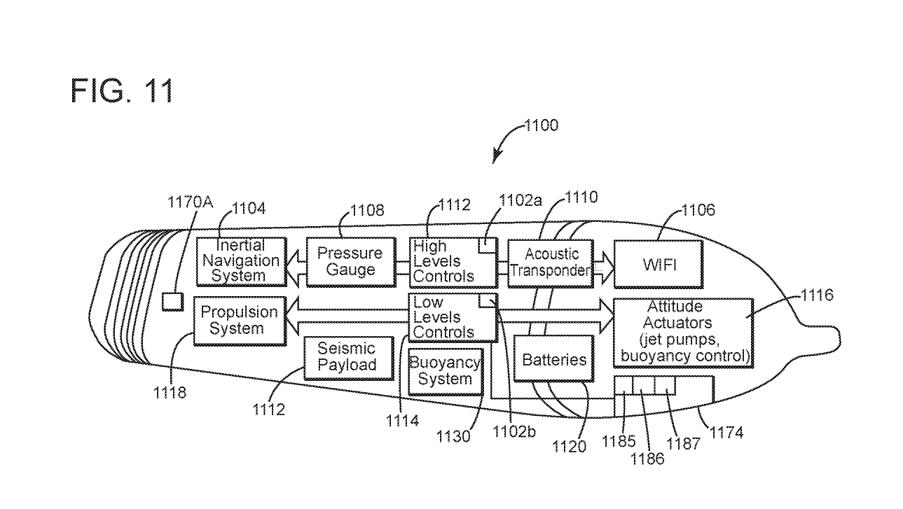

With regard to the internal configuration of the AUV, a possible arrangement is shown in FIG. 11. AUV 1100 has a CPU 1102a that is connected to inertial navigation system (INS) 1104 (or compass or altitude sensor and acoustic transmitter for receiving acoustic guidance from a mother vessel), wireless interface 1106, pressure gauge 1108 and transponder 1110. CPU 1102a may be located in a high level control block 1112. The INS, which is optional, is advantageous when the AUV's trajectory has been changed, for example, by an encounter with an unexpected object, e.g., fish, debris, etc., because the INS is capable of taking the AUV to the desired final position as it does for currents, wave motion, etc. Also, the precision of the INS may be high. For example, it is expected that for a target having a depth of 300 m, the INS is capable of steering the AUV within +/−5 m of the desired target location. However, the INS may be configured to receive data from the vessel to increase its accuracy. Alternately, the AUV may have no INS and the AUV is guided by an acoustic positioning system and this system receives acoustic commands from a surface vessel, an underwater base, etc. Note that the AUV 1100 may reach a depth of 300 m, for example, using a buoyancy system 1130. A CPU 1102b, in addition to the CPU 1102a, is part of a low-level control module 1114 configured to control attitude actuators 1116 and a propulsion system 1118. Propulsion system 1118 may include one or more propellers, or water pump jets, etc. One or more batteries 1120 may be located in the AUV 1100. A seismic payload 1122 is located inside the AUV for recording the seismic signals. Depth burying detection apparatus 1174 includes one or more outside burying sensors 1170A, inside reference sensor 1186, electrical circuit 1185, and optionally, a memory 1197. Those skilled in the art would appreciate that other modules suitable for seismic exploration under water may be added to the AUV.

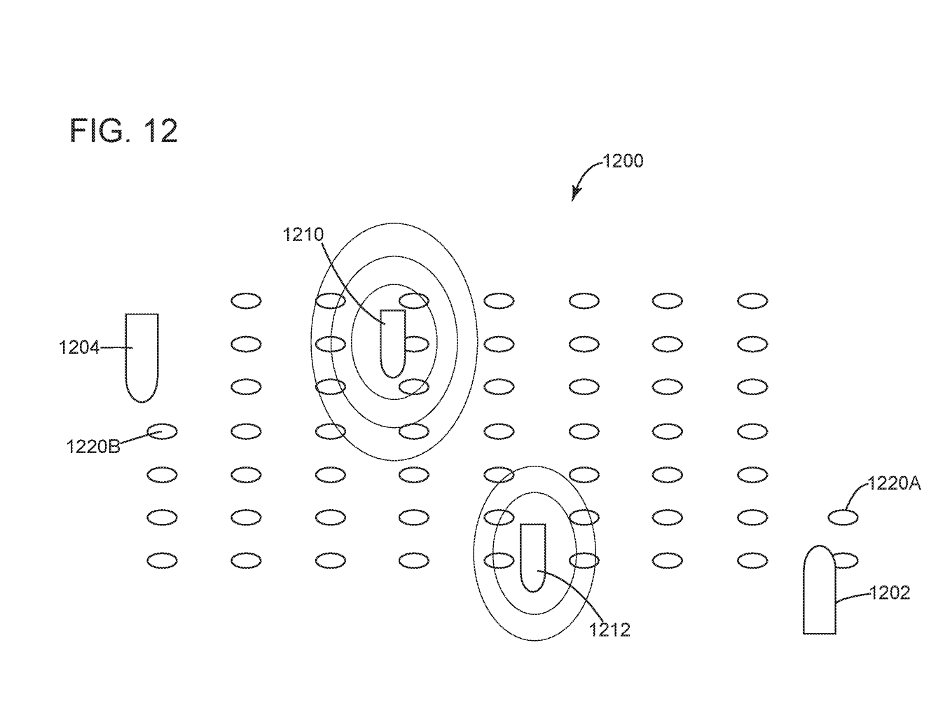

An embodiment for deploying and retrieving AUVs is now discussed with regard to FIG. 12, which shows a seismic acquisition system 1200 that includes a deployment vessel 1202 and a recovery vessel 1204. In one embodiment, the deployment vessel also performs the recovery vessel's functions. Deployment vessel 1202 is tasked to deploy AUVs 1220A while the recovery vessel 1204 is tasked to recover AUVs 1220B. In this embodiment, dedicated shooting vessels 1210 and 1212 follow their own path and generate acoustic waves. In one application, the deployment and recovery vessels do not tow source arrays. Although FIG. 12 shows two shooting vessels, those skilled in the art would appreciate that one or more than two shooting vessels may be used. In another application, the deployment and recovery vessels operate continuously. When the deployment vessel is empty, it switches positions with the recovery vessel. The shooting of the sources may continue while the deployment and recovery vessels switch positions.

The deploying and recovery processes discussed above are just some examples for illustrating the novel concepts of using AUVs for seismic data recording. Those skilled in the art would appreciate that these processes may be changed, adjusted or modified to fit various needs. For example, instead of deploying and collecting the AUVs from vessels, it is possible to use underwater bases. Underwater bases may be deployed by the vessels and act as a base for the AUVs. Underwater bases may be located on the ocean bottom or they may be suspended from one or more support vessels. Underwater bases are automatized not only to launch and retrieve AUVs, but also to transfer seismic data from the AUVs, charge their batteries, perform quality control actions, etc.

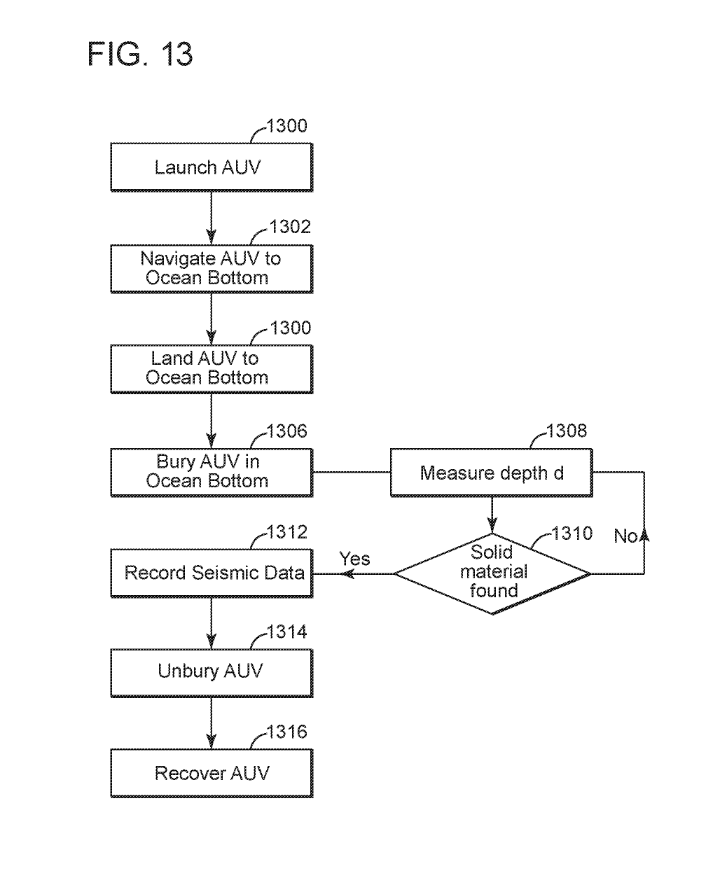

A method for deploying and burying an AUV is now discussed with regard to FIG. 13. In step 1300, the AUV is launched from a mother vessel or an underwater base. AUV navigates in step 1302 toward a target location on the ocean bottom. AUV navigates to this location using its propulsion system and/or buoyancy system. The INS or similar device helps the AUV to calculate and adjust its path to reach the target. Communications with the mother vessel can be ongoing for supporting the AUV in finding its target location. After the AUV lands in step 1304 on the ocean bottom, a burying step 1306 is initiated. In one application, it is possible that before starting the actual burying, the AUV's processor initiate the depth burying detection apparatus for measuring the conductivity of the AUV's environment. If the outside burying sensors return measurements indicating only the presence of sea water, the processor then instructs the burying mechanism to start the burying process. However, if after landing and prior to the burying, the outside burying sensors return measurements indicating that other materials are present, this may indicate that the AUV did not land on its base face, but maybe on one of its sides, which is undesirable. For this situation, the processor may restart the AUV's propulsion or buoyancy system to rectify the situation. In the event that the situation cannot be rectified after a certain time or a certain number of restarting the propulsion and/or buoyancy system, the processor may be configured to instruct the AUV to resurface or send to the mother vessel an indication that the landing has failed. The mother vessel may decide to instruct the AUV to come back to the surface or to record seismic data with a faulty landing.

Once the outside burying sensors return measurements consistent with the presence of sea water only, which indicate that the AUV has correctly landed on its base, the burying mechanism is started. However, note that this condition is no a requirement for starting the burying mechanism. The depth burying detection apparatus periodically or continuously measures in step 1308 the conductivity (or other parameter) of the ambient. In step 1310, as soon as one or more outside burying sensors (depending on the initial programming of the AUV, the number of the outside burying sensors, their distribution on the AUV, and the type of solids expected on the ocean bottom) determine the presence of solid material, e.g., sand, the processor instructs the burying mechanism to stop and the AUV is ready to record seismic data in step 1312. As already discussed above, there are various schemes for determining when the AUV has reached the desired burial depth, and these schemes may take into consideration one or more outside burying sensors. However, if the outside burying sensors do not detect solid material on the sides of the AUV in step 1310, the process returns to step 1308 and the depth burying detection apparatus continues to measure the ambient conductivity while the buring mechanism continues to bury the AUV. As previously discussed, the processor may be configured to stop the burying process based on one or more outside burying sensors.

Once the recording of seismic data is finalized, the processor starts the un-burying process in step 1314. Note that as previously discussed, the various shower heads distributed on the AUV's base may expelled water at a higher speed for this process. The depth burying detection apparatus may be activated in this step to determine when the AUV has been detached from the ocean bottom. When the processor determines that the AUV has detached from the ocean bottom, based on the measurements of the depth burying detection apparatus, the burying mechanism is stopped and the propulsion and/or buoyance systems are fully activated to either move the AUV to a new location or to bring it to the water surface for being retrieved by a vessel in step 1316.

The above method may be implemented with an AUV 420 for recording seismic signals during a marine seismic survey. In this embodiment, AUV 420 includes a body 421 having a base face 440 and first and second sides 442 and 444. A burying mechanism 468 is attached to the body 421 and configured to bury the base face 440 into the sea floor. A depth burying detection apparatus 474 is attached to the body 421 and configured to detect a presence of an ambient solid material (sand, rocks, etc.) on the first or second sides 442, 444 of the body. A seismic sensor 434 is attached to the body and configured to record seismic signals.

The depth burying detection apparatus 474 includes at least an outside burying sensor 470A located on the first side of the body, outside the body, at a given height d from the base face, an internal reference sensor 486 located inside the body, and an electrical circuit 485 connected to the outside burying sensor and the internal reference sensor. In one application, the electrical circuit applies a given voltage to the outside burying sensor and measures a corresponding current for calculating an ambient conductivity around the outside burying sensor. The electrical circuit also applies the given voltage (or a different voltage) to the inside reference sensor and measures a corresponding current for calculating a conductivity of the sea water. The electrical circuit compares the conductivity of the ambient (measured by the outside burying sensor) with the conductivity of the sea water (measured by the inside reference sensor), and if a difference between the two is equal to or larger than a threshold, the electrical circuit determines that the outside burying sensor is in contact with the ambient solid material.

The depth burying detection apparatus also includes a controller that turns off the burying mechanism when the ambient solid material is detected. In one application, the controller stops the burying mechanism when the depth burying detection apparatus detects the solid material. In another embodiment, the controller starts the burying mechanism when the depth burying detection apparatus detects only sea water. In still another embodiment, the controller controls the burying mechanism based on a measurement of the depth burying detection apparatus.

The depth burying detection apparatus detects the presence of the ambient solid material on the first or second side of the AUV by measuring with an outside burying sensor a conductivity of the ambient.

In another embodiment, a depth burying detection apparatus 474 that can be deployed on AUV 420 or other similar device includes at least an outside burying sensor 470A located on a first outside face 442 of the AUV, at a given height d from a base face 440 of the AUV, an internal reference sensor 486 located inside the AUV and exposed only to sea water, and an electrical circuit 485 located inside the AUV and connected to the outside burying sensor and the internal reference sensor.

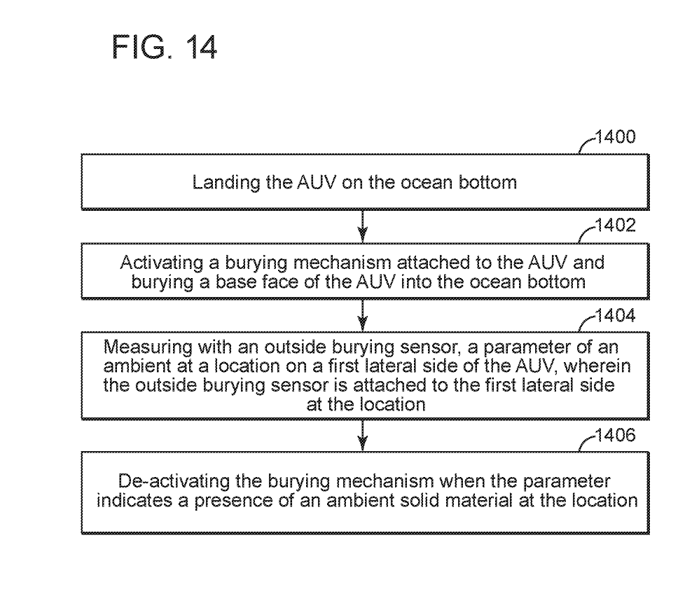

With the above discussed devices, it is possible according to an embodiment illustrated in FIG. 14 to control a burying process of AUV 420. The method includes a step 1400 of landing the AUV on the ocean bottom, a step 1402 of activating a burying mechanism, attached to the AUV, to bury a base face of the AUV into the ocean bottom, a step 1404 of measuring with an outside burying sensors, a parameter of an ambient at a location on a first lateral side of the AUV, wherein the outside burying sensor is attached to the first lateral side at the location, and a step 1406 of de-activating the burying mechanism when the parameter indicates a presence of an ambient solid material at the location.

One or more of the embodiments discussed above disclose an AUV configured to partially bury itself, after landing on the ocean bottom and prior to performing seismic recordings, and a depth burying detection apparatus and method for determining when the AUV has achieved a desired burial depth, that assures a good coupling between the seismic sensor and the ocean bottom. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. An autonomous underwater vehicle (AUV) for recording seismic signals during a marine seismic survey, the AUV comprising:
a body having a base face and first and second sides;
a burying mechanism attached to the body and configured to bury the base face into the sea floor;
a depth burying detection apparatus attached to the body and configured to detect a presence of an ambient solid material on the first or second side of the body; and
a seismic sensor configured to record seismic signals.

2. The AUV of claim 1, wherein the depth burying detection apparatus comprises:
an outside burying sensor located on the first side of the body, outside the body, at a given height d from the base face;
an internal reference sensor located inside the body; and
an electrical circuit connected to the outside burying sensor and the internal reference sensor.

3. The AUV of claim 2, wherein the electrical circuit applies a given voltage to the outside burying sensor and measures a corresponding current for calculating an ambient conductivity.

4. The AUV of claim 3, wherein the electrical circuit applies the given voltage to the inside reference sensor and measures a corresponding current for calculating a conductivity of the sea water.

5. The AUV of claim 4, wherein the electrical circuit compares the conductivity of the ambient with the conductivity of the sea water, and if a difference between the two is equal to or larger than a threshold, the electrical circuit determines that the outside burying sensor is in contact with the ambient solid material and a desired burial depth has been achieved.

6. The AUV of claim 5, wherein the depth burying detection apparatus also includes a controller that turns off the burying mechanism when the desired burial depth has been achieved.

7. The AUV of claim 1, further comprising:
a controller located inside the body and connected to the burying mechanism and the depth burying detection apparatus, the controller stopping the burying mechanism when the depth burying detection apparatus detects the solid material.

8. The AUV of claim 1, further comprising:
a controller located inside the body and connected to the burying mechanism and the depth burying detection apparatus, the controller starting the burying mechanism when the depth burying detection apparatus detects only sea water.

9. The AUV of claim 1, further comprising:
a controller located inside the body and connected to the burying mechanism and the depth burying detection apparatus, the controller controlling the burying mechanism based on a measurement of the depth burying detection apparatus.

10. The AUV of claim 1, wherein the depth burying detection apparatus detects the presence of the ambient solid material on the first or second side by measuring with an outside burying sensor a property of the ambient.

11. A depth burying detection apparatus to be attached to an autonomous underwater vehicle (AUV) for recording seismic signals during a marine seismic survey, the apparatus comprising:
an outside burying sensor located on a first outside face of the AUV, at a given height d from a base face of the AUV;
an internal reference sensor located inside the AUV and exposed only to sea water; and
an electrical circuit located inside the AUV and connected to the outside burying sensor and the internal reference sensor.

12. The apparatus of claim 11, wherein the electrical circuit applies a given voltage to the outside burying sensor and measures a corresponding current for calculating an ambient conductivity next to the first outside face.

13. The apparatus of claim 12, wherein the electrical circuit applies the given voltage to the inside reference sensor and measures a corresponding current for calculating a conductivity of the sea water.

14. The apparatus of claim 13, wherein the electrical circuit compares the conductivity of the ambient with the conductivity of the sea water, and if a difference between the two is equal to or larger than a given threshold, the electrical circuit determines that the outside burying sensor is in contact with ambient solid material.

15. The apparatus of claim 14, wherein the electrical circuit comprises:
a controller that turns off a burying mechanism of the AUV when the ambient solid material is detected.

16. The apparatus of claim 11, further comprising:
a controller located inside the AUV and connected to a burying mechanism of the AUV and the electrical circuit, the controller stopping the burying mechanism when a solid material is determined.

17. The apparatus of claim 11, further comprising:
a controller located inside the AUV and connected to a burying mechanism of the AUV and the electrical circuit, the controller starting the burying mechanism when the outside burying sensor detects only sea water.

18. The apparatus of claim 11, further comprising:
a controller located inside the AUV and connected to a burying mechanism of the AUV and the electrical circuit, the controller controlling the burying mechanism based on a measurement of the outside burying sensor.

19. A method for controlling a burying process of an autonomous underwater vehicle (AUV), the method comprising:
landing the AUV on the ocean bottom;
activating a burying mechanism, attached to the AUV, to bury a base face of the AUV into the ocean bottom;
measuring with an outside burying sensor, a parameter of an ambient at a location on a first lateral side of the AUV, wherein the outside burying sensor is attached to the first lateral side at the location; and
de-activating the burying mechanism when the parameter indicates a presence of an ambient solid material at the location.

20. The method of claim 19, wherein the parameter is a conductivity.
